(19) United States
(12) Patent Application Publication
(10) Pub. No.: US 2015/0151234 A1
(43) Pub. Date: Jun. 4, 2015

(54) AIR FILTER HAVING ADHESIVE TAPE WITH ADHESIVE SIDE EXPOSED TO AIR FLOW

(71) Applicant: Gregory T. Kavounas, Bellevue, WA (US)

(72) Inventors: William T. Colleran, Seattle, WA (US); Gregory T. Kavounas, Bellevue, WA (US)

(73) Assignee: Gregory T. Kavounas, Bellevue, WA (US)

(21) Appl. No.: 14/599,500

(22) Filed: Jan. 17, 2015

(51) Int. Cl. B01D 46/00; B03C 3/017

(52) U.S. Cl. CPC B01D 46/0005; B03C 3/017

(57) ABSTRACT

Air filter embodiments include a frame that can be placed within an air flow. The air filter may also include one or more tape segments of an air-impervious adhesive tape. The tape segment can have a primary surface on which an adhesive material has been deposited, and a secondary surface opposite the primary surface. The tape segment can be supported on the frame such that an exposed portion of the primary surface is exposed to the air flow. Accordingly, at least some of the particulates in the air flow may adhere to the exposed portion of the primary surface, and thus be removed from the air flow. In some embodiments a conventional filter is also provided within the frame, and thus the invention may provide a replacement air filter for existing installations where replacement air filters are used.

### BACKGROUND

Air purifiers employ air filters to filter air that has been polluted, and render it more suitable for breathing or use in industrial processes.

Conventional air filters trap airborne particulates when air is forced through a filter which physically captures particles larger than a certain size. For example, High-Efficiency Particulate Absorption (“HEPA”) is a type of air filter. Filters meeting the HEPA standard have many applications, including use in medical facilities, automobiles, aircraft and homes. To be designated a HEPA air filter, the US Department of Energy (DOE) requires that the filter remove (from the air flowing through the filter) 99.97% of particles that are 0.3 μm or larger. HEPA filters are usually more effective for particles larger than this minimum size. HEPA purifiers which filter all air flowing into a clean room must be arranged so that no air bypasses the HEPA filter. In dusty environments, a HEPA filter may follow an easily cleaned conventional filter (prefilter) which removes coarser impurities so that the HEPA filter requires less frequent cleaning or replacement.

Recent attention has focused on smaller and smaller particulates which contribute to air pollution and tend to escape conventional filters. Particulates whose diameter is smaller than 2.5 μm are called 2.5 PM and can cause respiratory and other health problems.

To capture very small particulates, conventional air filters would be more expensive and offer more resistance to air being forcibly transmitted through them. Accordingly, such conventional air filters would require larger fans consuming more power. For these and other reasons, filtering smaller particulates with conventional filters can be expensive for daily human use or in clean rooms constructed and operated for industrial processes sensitive to contamination.

### BRIEF SUMMARY

This description presents instances of air filters, the use of which may help overcome limitations of the prior art in removing particulates from air flows.

In embodiments, an air filter includes a frame that can be placed within an air flow. The air filter may also include one or more tape segments of an air-impervious adhesive tape. The tape segment can have a primary surface on which an adhesive material has been deposited, and a secondary surface opposite the primary surface. The tape segment can be supported on the frame such that an exposed portion of the primary surface can be exposed to the air flow. Accordingly, at least some of the particulates in the air flow may adhere to the exposed portion of the primary surface, and thus be removed from the air flow.

Air filters according to embodiments may be replaceable after becoming saturated. An advantage over the prior art may be that smaller particulates can be captured upon impact with the air-impervious adhesive tape, which might have escaped a conventional or HEPA air filter. Yet, for capturing these smaller particulates, the air flow need not be driven with more force than when a conventional air filter is used.

In some embodiments, air filters additionally include a conventional filter medium within the frame along with the tape segment. Accordingly, the invention may provide improved air filters for existing installations where the air filter is intended to be replaced periodically, such as furnace heaters, air conditioners, clean rooms, etc.

Another advantage may occur since embodiments are easy to implement when the adhesive air filter is made from adhesive tape that is already commercially available, and easily procured at low cost.

These and other features and advantages of this description will become more readily apparent from the Detailed Description, which proceeds with reference to the associated drawings in which:

### BRIEF DESCRIPTION OF THE DRAWINGS

FIG. 1A is a diagram of a sample air filter made according to embodiments, which has been placed in an air flow.

FIG. 1B is a diagram showing a detail and a filtering action of a tape segment of the air filter of FIG. 1A.

FIG. 2 is a perspective diagram of a sample air filter made according to embodiments.

FIG. 3 is a perspective diagram of another sample air filter made according to embodiments.

FIG. 4 is a diagram of a cross-section of a sample air filter made according to embodiments.

FIG. 5 is a diagram of a cross-section of another sample air filter made according to embodiments.

FIG. 6 is a diagram of a cross-section of one more sample air filter made according to embodiments.

FIG. 7 is a perspective diagram of a sample air filter made according to embodiments.

FIG. 8 is a diagram of a cross-section of an additional sample air filter made according to embodiments.

FIG. 9 is a diagram of a cross-section of one more sample air filter made according to embodiments.

FIG. 10 is a perspective diagram of a sample air filter made according to embodiments.

FIG. 11 is a diagram of a cross-section of a sample air filter made according to embodiments.

### DETAILED DESCRIPTION

As has been mentioned, the present description pertains to air filters for removing or filtering particulates from an air flow. The present description incorporates by reference co-pending U.S. patent application Ser. No. 14/340,552, filed on Jul. 24, 2014, with the original title: “AIR FILTER APPARATUS WITH ADHESIVE AIR FILTER (ADAF) AND COMPONENTS FOR AIR PURIFICATION, AND SYSTEMS USING THE SAME.” Embodiments are now described in more detail.

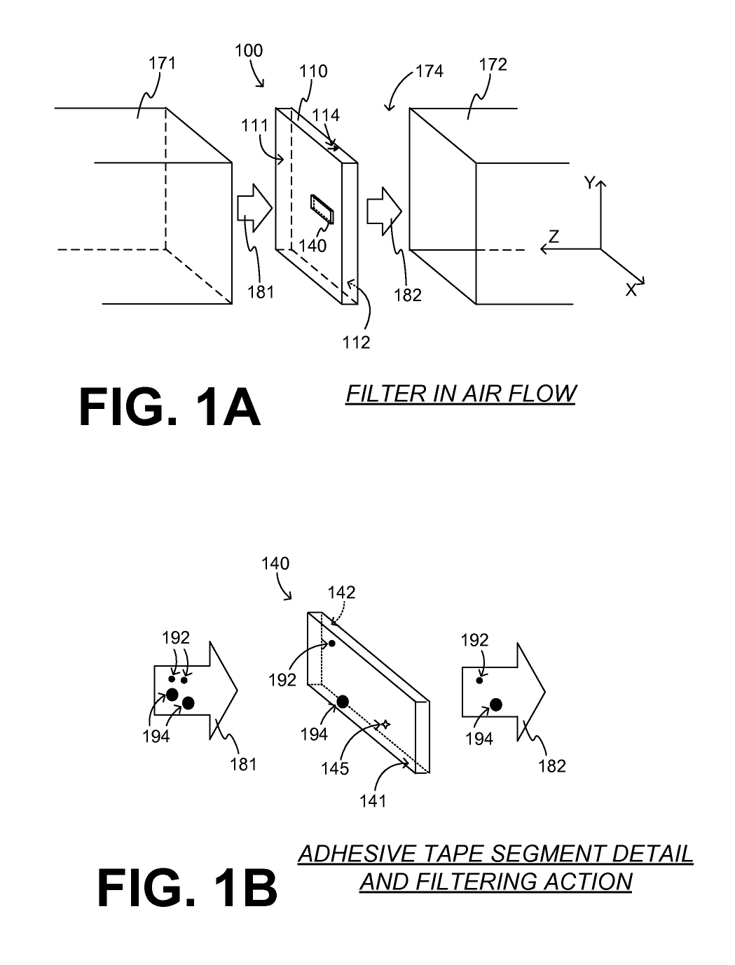

FIG. 1A depicts a sample air filter 100, which is made according to embodiments. Air filters may also be called just filters for simplicity in the present description. Filter 100 has been placed in an air flow that is designated by arrows 181, 182, and is also known as air stream 181, 182. From the perspective of filter 100, air flow 181, 182 has an incoming portion 181 and an outgoing portion 182. Filter 100 is configured to remove particulates from air flow 181, 182 by capturing particulates of incoming air flow portion 181, and thus not permitting them to be in outgoing air flow portion 182; in other words, eliminating them from the air flow.

Air flow 181, 182 may be implemented in a number of ways. In the example of FIG. 1A, air flow 181, 182 is substantially confined within each of duct portions 171, 172, which leave an intervening space 174 between them. Filter 100 has been inserted in space 174. In FIG. 1A, space 174 is shown as exaggerated compared to the size of filter 100 so as to not obscure detail. In practice, in some embodiments, filter 100 is sized to fit snugly within space 174 while still being loose enough for easy insertion and removal. In some instances, only one of duct portions 171, 172 is provided, while the other may be a grille of a cover, the space inside a room, the space outside, and so on. In addition, duct portions 171, 172 may be partly connected, and/or parts of a system that further heats or cools the air, and so on.

A system of x, y and z axes is given in FIG. 1A, and may apply also to the other drawings of this description. Air flow 181, 182 has a cross section in the x-y plane, and travels along a primary direction that is in the z axis. Air filter 100 preferably covers the entire cross section of air flow 181, 182, although such is not necessary.

Filter 100 includes a frame 110, which is distinct from duct portions 171, 172. In embodiments, frame 110 includes a front opening 111 and a back opening 112. Frame 110 is configured to be placed within air flow 181, 182, such that the air flow 181, 182 enters frame 110 via front opening 111 and exits frame 110 via back opening 112. Accordingly, the air flow may continue within frame 110. Preferably, frame 110 is sized to fit snugly in space 174 while being loose enough for easy insertion or removal as mentioned above. Typical widths for space 174 in furnace heaters in the US are 1″, 4″, etc. In such cases, the actual width in the z direction of frame 110 can be a little less.

An indicator arrow 114 is depicted on frame 110. Indicator arrow 114 may indicate which direction frame 110 should be facing with respect to air flow 181, 182. This way, the user will know the proper orientation, when inserting filter 100 in space 174.

Filter 100 also includes a tape segment 140. For clarity, only one, small tape segment 140 is shown in FIG. 1A but, and as will be seen later in this document, there can be more than one tape segments; and/or the tape segment(s) can be longer than shown; and/or the tape segment(s) can be wider than shown, even having the width of a sheet. The numbers, forms, orientations, shapes and sizes of such tape segments can be designed to improve the filtering action, reduce cost, and improve ease of deployment, as will be apparent in view of the present description.

Referring to FIG. 1B, tape segment 140 is of a substantially air-impervious adhesive tape. Accordingly, tape segment 140 can be made, for example, by cutting segments from a roll or other provision of such a tape. In addition to, or instead of cutting, tape segment may be made in the desired shape and size by suitable processing. Such a substantially air-impervious adhesive tape, and therefore also tape segment 140, may have two surfaces opposite each other. In particular such a substantially air-impervious adhesive tape, and therefore also tape segment 140, may have a primary surface 141 on which an adhesive material 145 has been deposited, and a secondary surface 142 opposite primary surface 141. Adhesive material 145 is artificially designated with a small icon which, however, is not intended to depict the appearance of the adhesive material. Rather, the icon is intended to indicate a side of tape segment 140 that is sticky due to the adhesive that has been deposited thereon during manufacture. The adhesive may be deposited during manufacture before or after tape segment 140 is cut from a roll or other provision of such tape. For implementing such substantially air-impervious adhesive tapes one may use, for example, commercially available adhesive tapes such as masking tape, packaging tape, cellophane tape, Scotch® tape, duct tape, pressure-sensitive adhesive tapes, and so on.

Tape segment 140 is supported on frame 110. Many ways are possible for this support including ways of supporting tape segment 140 within frame 110. Sample such ways are described later in this document. FIG. 1A does not show any such way of supporting, because it is only generic in this regard. Importantly, tape segment 140 is supported such that at least an exposed portion of primary surface 141 is exposed to air flow 181, 182. In many embodiments, the exposed portion of primary surface 141 is exposed to air flow 181, 182 that is within frame 110. As will be seen, the exposed portion of primary surface 141 performs filtering, and therefore has an area that can be advantageously larger and contacts the air flow along more of its path. For example, the area can be at least 10 cm², etc. Larger such total areas may be attained with more and/or larger tape segments than suggested by FIG. 1B; for example, such total areas can be at least 40 cm², etc.

The filtering action of tape segment 140 may be accomplished by adhesive material 145. In particular, forcing airflow 181, 182 in contact with the exposed portion of primary surface 141 may result in at least some of the particulates in air flow 181, 182 adhering to the exposed portion of primary surface 141. In FIG. 1B, incoming air flow portion 181 is shown as having two small particulates 192 and two large particulates 194. Of those, half have adhered to the exposed portion of primary surface 141, while the other half have remained in the air flow, and are present in the outgoing portion 182 of the air flow.

Adhesion of particulates to tape segment 140 may be assisted by electrostatic charging. In some embodiments, at least a section of tape segment 140 may have been electrostatically charged in advance. In some embodiments, the particulates in the air flow have been electrostatically charged before they reach filter 100.

Various ways of supporting tape segment 140 on frame 110 are now described in more detail. These ways also show different configurations of one or more tape segments. In embodiments, the air flow substantially does not flow through tape segment 140, because tape segment 140 is of a substantially air-impervious adhesive tape. Rather, as will be seen, air flow 181, 182 substantially flows around tape segment 140 (while the air flow would normally flow through a conventional air filter).

In some embodiments, the tape segment is supported on the frame due to adhesion of the adhesive material that has been deposited on the primary surface. Examples are now described.

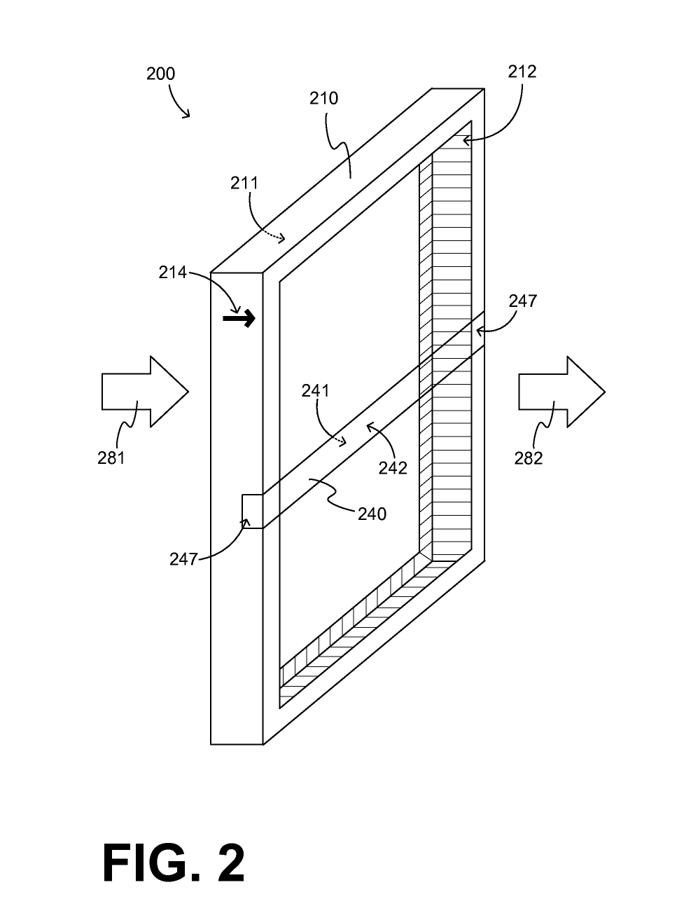

FIG. 2 is a diagram of a sample air filter 200 made according to embodiments. Filter 200 has a frame 210. In addition, frame 210 has a front opening 211 and a back opening 212. Incoming air flow portion 281 is received via front opening 211, and outgoing air flow portion 282 exits via back opening 212. In the example of FIG. 2, frame 210 has an indicator arrow 214 that indicates the proper orientation of frame 210 with respect to an air flow 281, 282.

In the example of FIG. 2, the edges and corners of frame 210 have a generally U-shaped peripheral cross-section so as to help frame 210 retain its shape. Frame 210 can be made from any suitable material, such as metal or rigid polymeric materials. Or, a cardboard or pasteboard can be formed into the desired shape, and then be glued with a suitable adhesive to the right shape, if it will not be deformed too much by the forces that are transferred to the edges by tape segment 240 being impacted by incoming air flow portion 281. Knowledge of the art for constructing frames of conventional air filters may help in optimizing mechanical design of frames for embodiments of filters based on the current description.

In FIG. 2, a single tape segment 240 is provided, which can be as tape segment 140. Tape segment 240 has a primary surface 241 on which an adhesive material has been deposited. Tape segment 240 also has a secondary surface 242 opposite primary surface 241. The adhesive material on primary surface 241 is not indicated separately in FIG. 2, since primary surface 241 faces more into the drawing than out of the drawing.

Tape segment 240 is supported on frame 210 due to adhesion of the adhesive material that has been deposited on primary surface 241. In particular, two ends 247 of tape segment 240 are taped on frame 210. This attachment method is simple when tape segment 240 is a segment of an adhesive tape that is pressure sensitive. The advantage is that no separate means is required for attaching tape segment 240 to frame 210. A challenge is that tape segment 240 is not fully contained within frame 210, and may become snagged upon insertion or removal of filter 200 in the space where it will encounter air flow 281, 282.

In FIG. 2, then, primary surface 241 may remove particulates from incoming air flow portion 281 that impacts it. Of course, it will be recognized that filter 200 is not the most effective configuration for a filter according to embodiments, for a number of reasons. First, a large portion of incoming air flow portion 281 will bypass without impacting tape segment 240, and thus will not be filtered. Second, incoming air flow portion 281 flows perpendicularly to a tape plane of tape segment 240, which may exert forces on frame 210. This may require tape segment 240 to have a tape support, and/or frame 210 to be stronger than it might otherwise be. Filter 200 does succeed, however, in exposing a large exposed portion of primary surface 241 to incoming air flow portion 281, relative to the entire area of primary surface 241. Indeed, from the entire area of primary surface 241, only ends 247 are not part of the exposed portion.

In some embodiments, the tape segment is supported between the two planes defined by the front opening and the back opening of the frame. These embodiments enjoy the advantage that adhesive surfaces are contained wholly within the frame and will thus be less likely to be contacted or damaged by foreign objects during normal handling of the filter. Examples are now described.

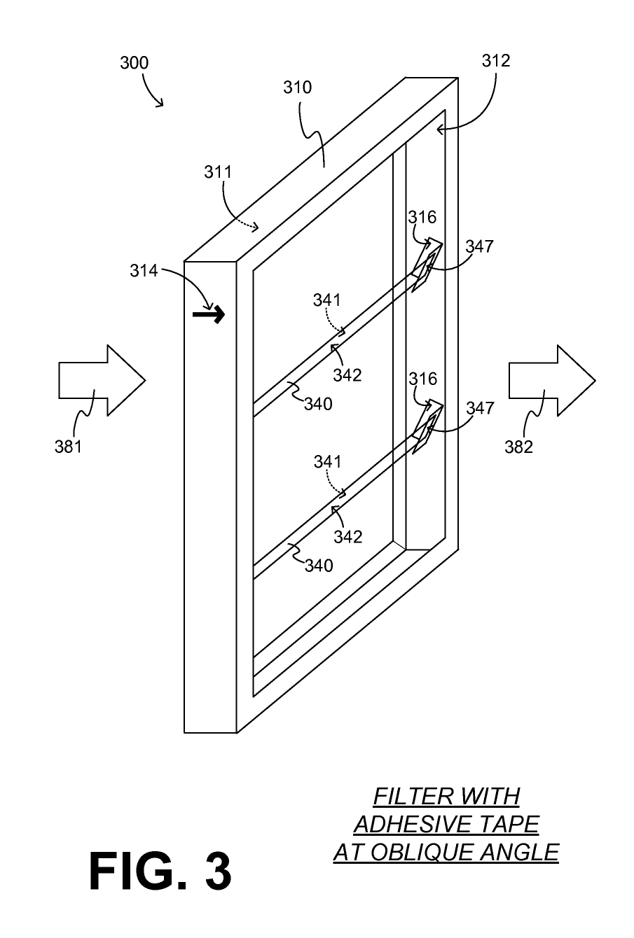

FIG. 3 is a perspective diagram of another sample air filter 300 made according to embodiments. Filter 300 includes a frame 310, which can be as described for frame 210. Frame 310 includes a front opening 311 and a back opening 312. An indicator arrow 314 indicates the proper orientation of frame 310 within an air flow 381, 382.

Filter 300 includes two tape segments 340, which can be as described for tape segment 140. Tape segments 340 have respective primary surfaces 341, on which an adhesive material has been deposited. Tape segments 340 also have respective secondary surfaces 342 opposite respective primary surfaces 341.

Tape segments 340 are supported on frame 310 such that at least respective exposed portions of their respective primary surfaces 341 are exposed to air flow 381, 382, similarly to what was mentioned above for a single tape segment. In the example of FIG. 3, frame 310 includes tabs 316 between front opening 311 and back opening 312. Each of tabs 316 can be folded so as to present two sections: one section for attaching tab 316 to frame 310, and another section for tape segment 340 to be supported by tab 316. In this case, supporting is by adhesion of ends 347, similarly to how ends 247 are adhered to. Tabs 316 can be made of cardboard whose one side can thus be glued on frame 310, and more particularly on its inside. An advantage of tabs 316 is that they can be provided at the desired angle with respect to the rest of frame 310.

Tape segments 340 are substantially parallel to each other, although this configuration is not essential. Air pressure from air flow 381, 382 will induce forces on tape segments 340. These forces may move tape segments 340 somewhat.

In FIG. 3, air flow 381, 382 travels along a primary direction that is left-to-right. The exposed portions of primary surfaces 341 are planar, in other words, these exposed portions are disposed in respective tape planes. These tape planes are at an oblique angle with respect to the primary direction of air flow 381, 382. By “oblique” it is meant neither parallel with nor perpendicular to the primary direction of air flow 381, 382, but instead slanting. The oblique angle is realized by proper placement of tabs 316.

Using oblique angles may present advantages. First the adhesive of primary surfaces 341 contact incoming air flow portion 381, for removing particulates, as would be needed. In addition, the air flow may be locally deflected by tape segments 340, which means being sent towards a different direction, because tape segments 340 are air-impervious. The deflection of the oblique angle, however, is not a dispersal of the incoming air-flow portion as was the case in FIG. 2, but a mere re-direction.

The deflection exerts a force on the air flow, which exerts a counter-force that is applied to tape segments 340. The counter-force has a component along the primary direction of air flow 381, 382, and another component downwards. Tape segments 340 may be flexible, and these counter-force components may move them somewhat, as mentioned above. Care should be taken to prevent tape segments 340 from moving enough so that they interfere with each other, or contact frame 310, and adhere there. Both components of the counter-force may affect frame 310, which should be sturdy enough for the application.

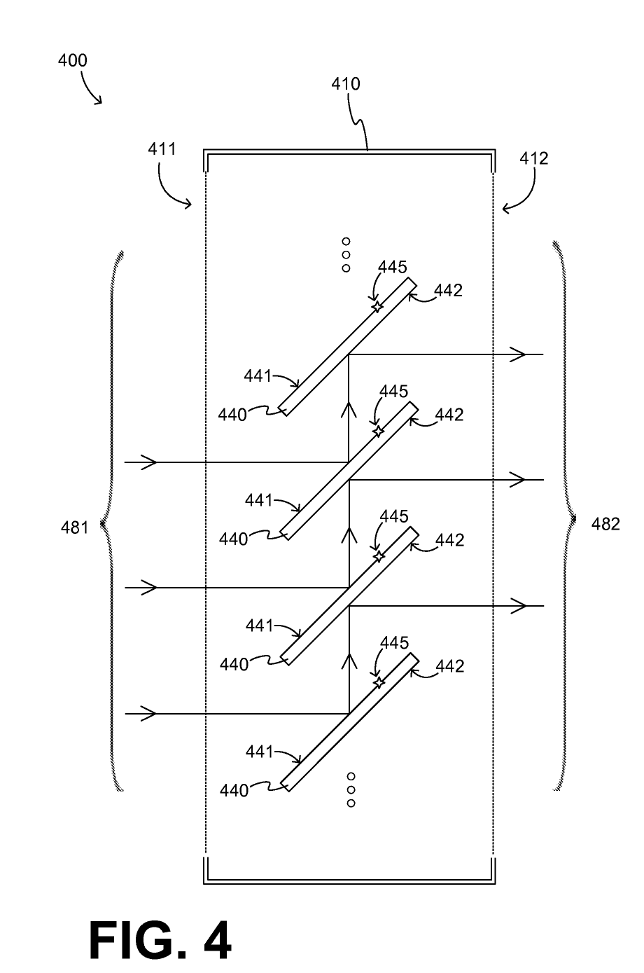

FIG. 4 is a diagram of a cross-section of a sample air filter 400 made according to embodiments. Filter 400 includes a frame 410, which can be as described for frame 210. Frame 410 includes a front opening 411 and a back opening 412. Filter 400 is within an air flow 481, 482 that travels in a horizontal direction.

Filter 400 includes tape segments 440, of which only four are shown. Tape segments 440 can be as tape segment 140, and be supported within frame 410 in any suitable way, such as was described above in FIG. 3. Tape segments 440 have respective primary surfaces 441, on which an adhesive material 445 has been deposited. Tape segments 440 also have respective secondary surfaces 442 opposite respective primary surfaces 441.

Tape segments 440 are at an oblique angle, which in this case is of 45°, with respect to the horizontal direction of air flow 481, 482. In this embodiment, sections of incoming air flow portion 481 are deflected twice, and then exit as sections of outgoing air flow portion 482. The first deflection is from primary surfaces 441, and the second deflection is from secondary surfaces 442. The second deflection is possible because the tape segments are close enough to each other, unlike with the example of FIG. 3. Accordingly, most of tape segments 440 experience a downward and an upward force. This likely is not true for those of the tape segments (not shown) that are at the top and the bottom of frame 410. Since most of tape segments 440 experience both a downward and an upward force, an advantage of filter 400 is that these vertical forces tend to cancel, exerting less net downward force on their means of supporting them on frame 410.

In FIG. 4 filtering is by action of adhesive material 445 of primary surfaces 441. The respective exposed portions of the respective primary surfaces 441 have a larger total area, for example at least 40 cm².

In addition, further geometries are possible that can cause the air flow to impact an adhesive surface multiple times, to improve capture of the particulates upon each impact. Such geometries often capitalize on the previously mentioned oblique mounting angles. In some embodiments, double-sided adhesive tape may be used advantageously. In other words, an adhesive material may have been deposited also on the secondary surface, and the tape segment can be supported on the frame such that at least an exposed portion of the secondary surface is exposed to the air flow. This way at least some of the particulates in the air flow may adhere also to the exposed portion of the secondary surface. An example is now described.

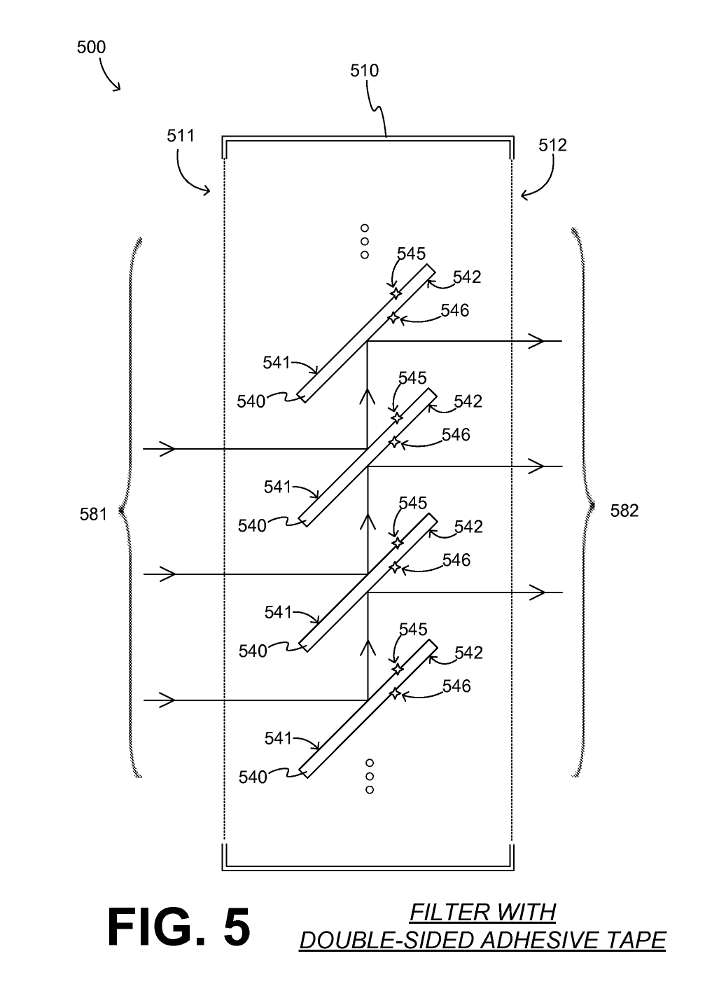

FIG. 5 is a diagram of a cross-section of another sample air filter 500 made according to embodiments. It will be recognized that filter 500 has similarities to filter 400. In particular, filter 500 includes a frame 510, which can be as described for frame 210. Frame 510 includes a front opening 511 and a back opening 512. Filter 500 is within an air flow 581, 582.

Filter 500 includes tape segments 540, of which only four are shown. Tape segments 540 can be as tape segment 140, and be supported within frame 510 in any suitable way, such as was described above in FIG. 3. Tape segments 540 have respective primary surfaces 541, on which an adhesive material 545 has been deposited. Tape segments 540 also have respective secondary surfaces 542 opposite respective primary surfaces 541. Adhesive material 546 has been deposited on secondary surfaces 542. Adhesive material 546 may be the same as adhesive material 545, although that is not necessarily the case. For example, if tape segments 540 are cut from a roll, the roll may need to have also a releasing agent on one side, but not on the other.

Tape segments 540 are at the same oblique angle of 45° with respect to the horizontal direction of air flow 581, 582. As with FIG. 4, sections of incoming air flow portion 581 are deflected twice, and then exit as sections of outgoing air flow portion 582.

Filtering is by action of adhesive material 545 of primary surfaces 541 and also of adhesive material 546 of secondary surfaces 542. Due to symmetries, etc., the exposed portion of each secondary surface 542 may have an area as large as that of the primary surface, such as at least 10 cm², etc.

In some embodiments, the tape segments are arranged to form constrictions to the air flow. These constrictions may cause adhesive surfaces of the tape segments to contact even more of the air flow, thus having the opportunity to remove even more particulates. Examples are now described.

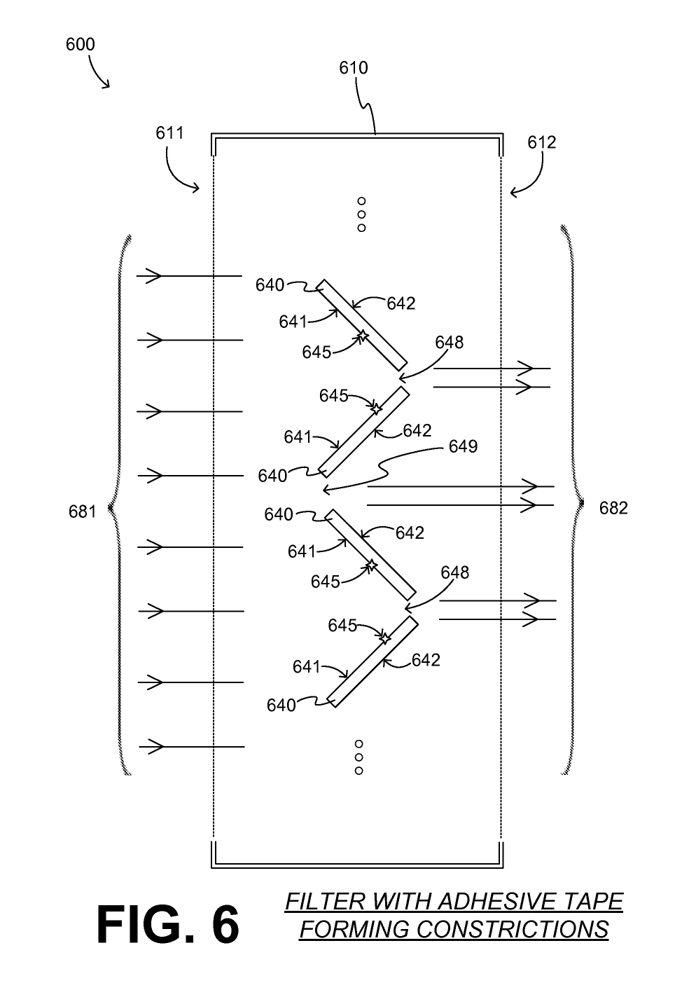

FIG. 6 is a diagram of a cross-section of a sample air filter 600 made according to embodiments. As previously, filter 600 includes a frame 610. Frame 610 includes a front opening 611 and a back opening 612. Filter 600 is within an air flow 681, 682 that travels in a horizontal direction.

Filter 600 includes tape segments 640, of which only four are shown. Tape segments 640 can be as tape segment 140, and be supported within frame 610 in a suitable way, such as was described above in FIG. 3. Tape segments 640 have respective primary surfaces 641, on which an adhesive material 645 has been deposited. Tape segments 640 also have respective secondary surfaces 642 opposite respective primary surfaces 641. In this arrangement, tape segments 640 need only be of a one-sided adhesive tape.

The top two and the bottom two of the shown tape segments 640 can be advantageously considered in pairs. The top pair has the two shown tape segments 640, which are at the sample oblique angles of +45° and −45° with respect to the horizontal direction of air flow 681, 682. These angles are positive and negative signifying, in this case, that the top pair thus forms a constriction 648 to the air flow. The bottom pair forms another constriction 648 to the air flow. Between the top pair and the bottom pair there is a substantially non-constricted path 649.

Constrictions 648 may force the air to circulate in ways that more particulates may be captured by primary surfaces 641, before exiting and joining outgoing portion of air flow 682. The circulation may increase if constrictions 648 are narrower, for example by bringing tape segments 640 closer together. Such a configuration, however, risks that tape segments 640 might move and thus adhere to each other. A mitigating approach to this risk is now described.

In some embodiments, a tape support structure is provided. The tape support structure can be configured to support the tape segments on the frame. Accordingly, motion of the tape segments can be restricted, and better effects may be achieved. Examples are now described.

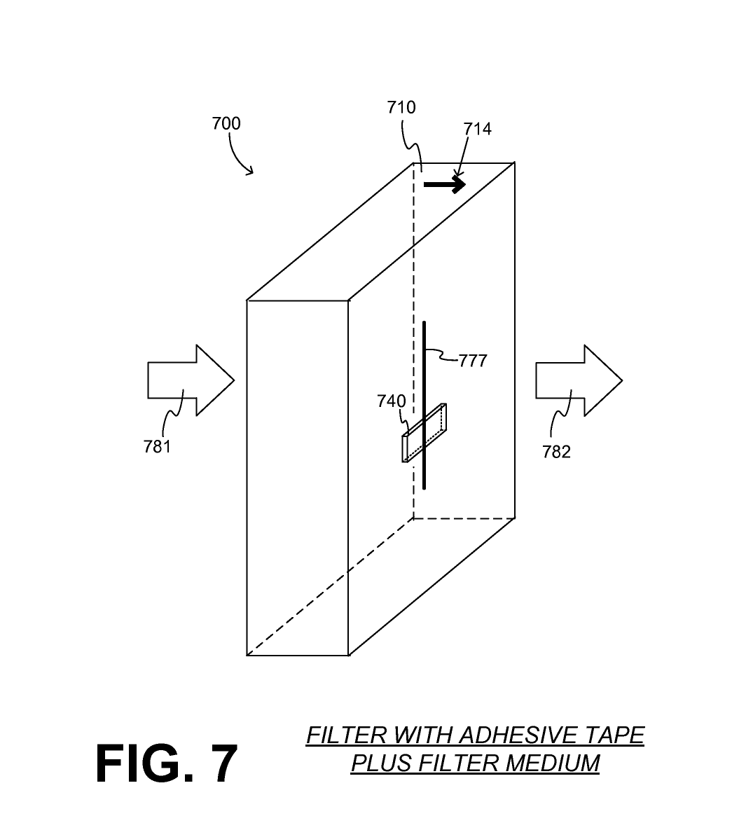

FIG. 7 is a perspective diagram of a sample air filter 700 made according to embodiments. Filter 700 includes a frame 710. Filter 700 is within an air flow 781, 782. An indicator arrow 714 indicates the proper orientation of frame 710 within air flow 781, 782.

Filter 700 includes at least one tape segment 740, and often more than one. Tape segment 740 can be as tape segment 140, and is shown generically for tape segments that may be implemented in such embodiments.

Filter 700 also includes a tape support structure 777, which is only shown generically in FIG. 7. Tape support structure 777 can be configured to support tape segment 740 on frame 710. Tape support structure 777 may be implemented in a number of ways, and have various components for implementing its functions. For example, tabs 316 are a form of a tape support structure. In some embodiments, tape support structure includes a grid (not shown), such as a grid made of wire or cardboard or other material. A grid may include parallel spaced rectangular thin plates that are vertical with respect to air flow 781, 782. The plates may have slits at angles oblique to it, for receiving therein the tape. Depending on the implementation, it may be desirable for at least some components of the grid to be substantially rigid. Tape support structure 777 can also be implemented otherwise, such as with fabrics, twine, wire netting, etc. If tape support structure 777 includes a netting component, the latter can be in the form of, for example, a mesh that is similar to chicken-wire.

Tape support structure 777 is preferably implemented so as to not impact adversely air flow 781, 782. In other words, components of tape support structure 777 may either substantially avoid air flow 781, 782, or help steer it beneficially. All the examples of the previous drawings may be implemented with such a tape support structure 777.

Tape support structure 777 may be attached to the frame, or not. In embodiments that include a grid, tape support structure 777 can have dimensions along any one or more of the x, y, and z axes that help it substantially fit within frame 710. Such a substantial fit may prevent tape support structure 777 from moving within frame 710, and thus make attachment unnecessary.

Tape segment 740 can be adhered to tape support structure 777 in a number of ways. In some embodiments, glue or other adhesive may be used. In some instances, tape segment 740 itself is double-sided. In other words, an adhesive material has been deposited also on its secondary surface, and tape segment 740 is adhered to tape support structure 777 due to adhesion of the adhesive material that has been deposited on the secondary surface. Of course, tape support structure 777 may present a suitable surface to enable such adhesion. This surface may also have holes, in fact itself be grid-like, so as to reduce the amount of total weight. Adhesion is not necessary where a tape segment 740 has been inserted in a slit of a plate.

An advantage of employing a tape support structure is that elaborate structures may be realized with the adhesive tape segments. An example is now described.

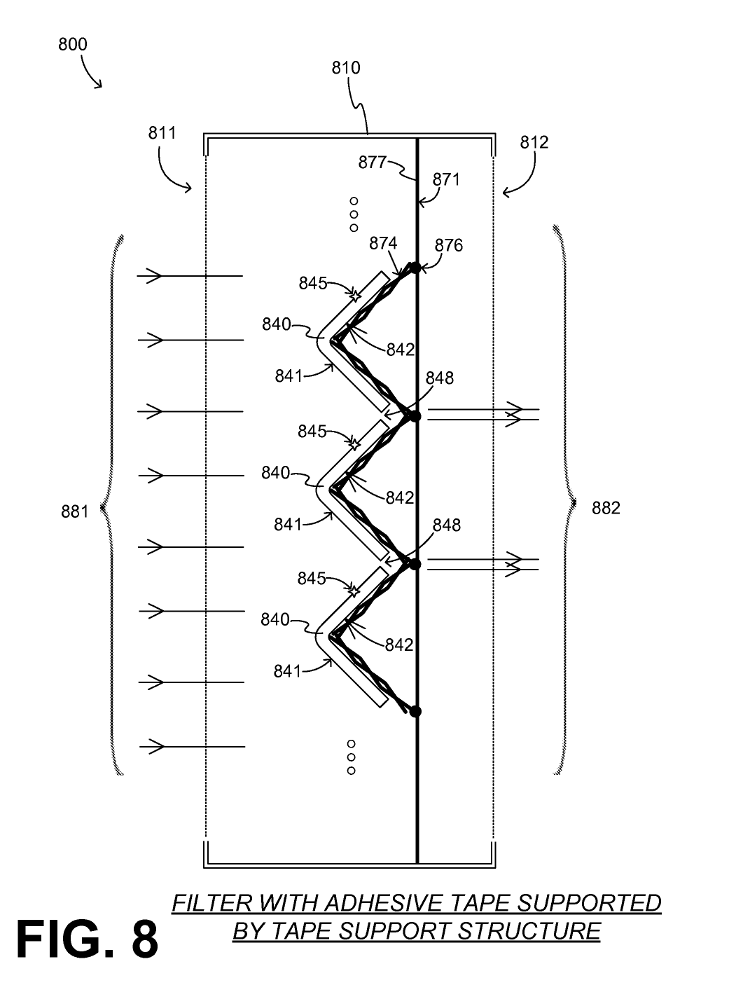

FIG. 8 is a diagram of a cross-section of a sample air filter 800 made according to embodiments. As previously, filter 800 includes a frame 810. Frame 810 includes a front opening 811 and a back opening 812. Filter 800 is within an air flow 881, 882.

Filter 800 includes tape segments 840, of which only three are shown. Tape segments 840 can be as tape segment 140. They have respective primary surfaces 841, on which an adhesive material 845 has been deposited. Tape segments 840 also have respective secondary surfaces 842 opposite respective primary surfaces 841. In this arrangement, tape segments 840 need only be of a one-sided adhesive tape.

Filter 800 also includes a tape support structure 877, of which only a few components are shown. Tape support structure 877 can be configured to support tape segments 840 on frame 810.

In this example, tape support structure 877 includes at least one vertical column 871, and perhaps more. Vertical column 871 spans the entire interior dimension of frame 810 for reasons mentioned above. Similarly, tape support structure 877 may include at least one horizontal column (not shown), and perhaps more. Any vertical and horizontal columns together may form a grid. The previously mentioned plates would be like such a column, except with more width along the z direction, and possibly made of cardboard. A tape support structure with substantial width along the z direction would thus be three-dimensional. In fact, such a tape support structure could be the entire frame, and support tape segments 840 within it. In fact, such a tape support structure could further be used together with an air filter medium (not shown in FIG. 8), such as air filter medium 920. The air filter medium could be attached to it, or they could both be within a frame. Such a tape support structure could provide support for such an air filter medium against incoming air flow portion 881, and therefore such an air filter medium might not need its own filter support structure.

In addition, tape support structure 877 includes pleats 874. Pleats 874 are parallel to a direction that is called a tape direction. In this example, the tape direction is the direction of the x-axis of FIG. 1A, which is perpendicular to the page. Pleats 874 are attached to vertical column 871 at nodes 876. Attachment can be with any suitable means. For example, if the entire tape support structure 877 is made of metal, this attachment can be via soldering.

Filter 800 has tape segments 840 arranged on pleats 874. It will be appreciated that pleats 874 are arranged so that tape segments 840 form constrictions 848 to air flow 881, 882, similarly to constrictions 648 in FIG. 6. A difference, however, is that tape segments 840 are wider, and do not leave a substantially non-constricted path similar to path 649. Accordingly, tape segments 840 may contact more of incoming air flow portion 881. Plus, since any motion of tape segments 840 is restricted by pleats 874, tape segments 840 may be safely mounted closer together than in FIG. 6.

In some embodiments, the above mentioned tape segments are combined with a conventional air filter. In some embodiments, the combination is contained within a single frame, which can further be a frame used for a conventional air filter. Such an embodiment may present the advantage that the combination may be used in existing systems that have air flows and use air filters to remove particulates from them. Examples are now described.

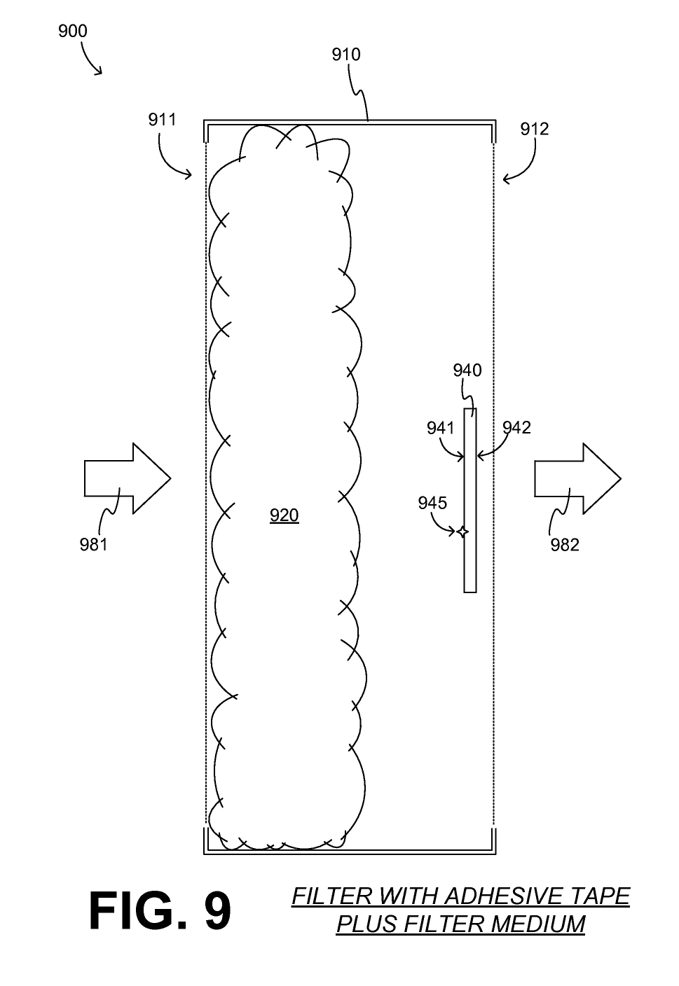

FIG. 9 is a diagram of a cross-section of a sample air filter 900 made according to embodiments. As previously, filter 900 includes a frame 910. Frame 910 includes a front opening 911 and a back opening 912. Filter 900 is within an air flow 981, 982.

Filter 900 also includes at least one tape segment 940, and often more than one. Tape segment 940 can be as tape segment 140, and is shown generically for tape segments that may be implemented in such embodiments. Tape segment 940 has a primary surface 941, on which an adhesive material 945 has been deposited. Tape segment 940 also has a secondary surface 942 opposite primary surface 941. Secondary surface 942 may or may not have had adhesive deposited on it.

Filter 900 additionally includes an air filter medium 920 that is air-permeable. Of course, air filter medium 920 is distinct from tape segment 940, although the two can be in close proximity, even contacting. Air filter medium 920 is configured to remove at least some of the particulates from air flow 981, 982. Air filter medium 920 can be made as is known in the art for HEPA filters. HEPA filters may be made of a mat of randomly arranged fibers. These fibers are typically composed of fiberglass, and have diameters between 0.5 μm and 2.0 μm. Key factors affecting function can be fiber diameter, filter thickness, and face velocity. The air space between HEPA filter fibers can be much greater than 0.3 μm.

Air filter medium 920 can be supported on frame 910. For example, a periphery of its web can be secured to frame 910. In the example of FIG. 9, both air filter medium 920 and tape segment 940 are supported between front opening 911 and back opening 912. In some embodiments, a filter support structure (not shown) is provided to support air filter medium 920 against the force of incoming air flow portion 981.

In the example of FIG. 9, air filter medium 920 and tape segment 940 are supported on frame 910 such that the particulates in air flow 981, 982 encounter air filter medium 920 before they encounter tape segment 940. Thus, air filter medium 920 may capture many particulates, and thus prevent tape segment 940 from becoming prematurely saturated, as was explained in the incorporated co-pending U.S. patent application Ser. No. 14/340,552.

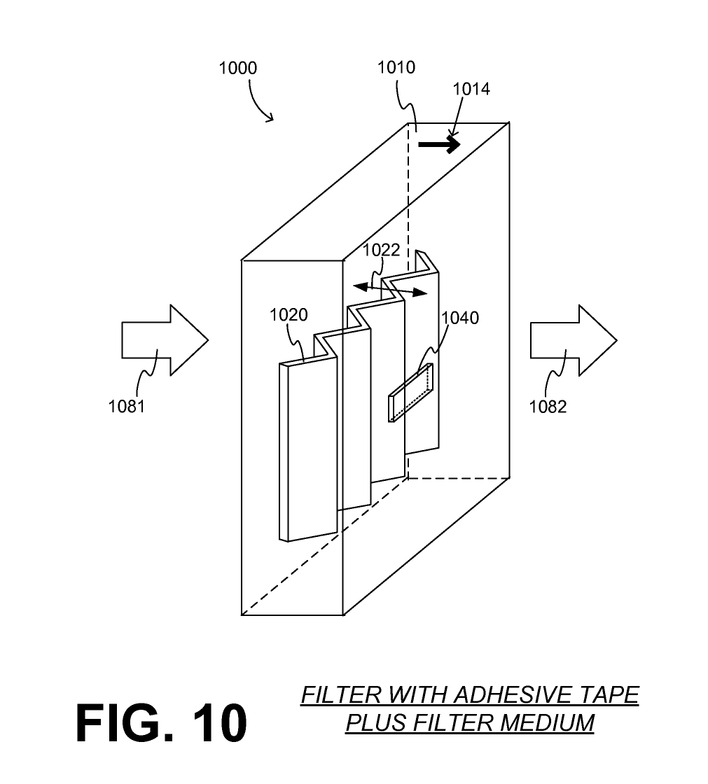

FIG. 10 is a perspective diagram of a sample air filter 1000 made according to embodiments. Filter 1000 includes a frame 1010. Filter 1000 is within an air flow 1081, 1082. An indicator arrow 1014 indicates the proper orientation of frame 1010 within air flow 1081, 1082.

Filter 1000 also includes at least one tape segment 1040, and often more than one. Tape segment 1040 can be as tape segment 140, and is shown generically for tape segments that may be implemented in such embodiments.

Filter 1000 additionally includes an air filter medium 1020 that is air-permeable. Air filter medium 1020 is an embodiment of air filter medium 920. Air filter medium 1020 is folded into pleats, which are parallel to a direction that is called a filter direction. In this example, the filter direction is the vertical direction of the y-axis of FIG. 1A.

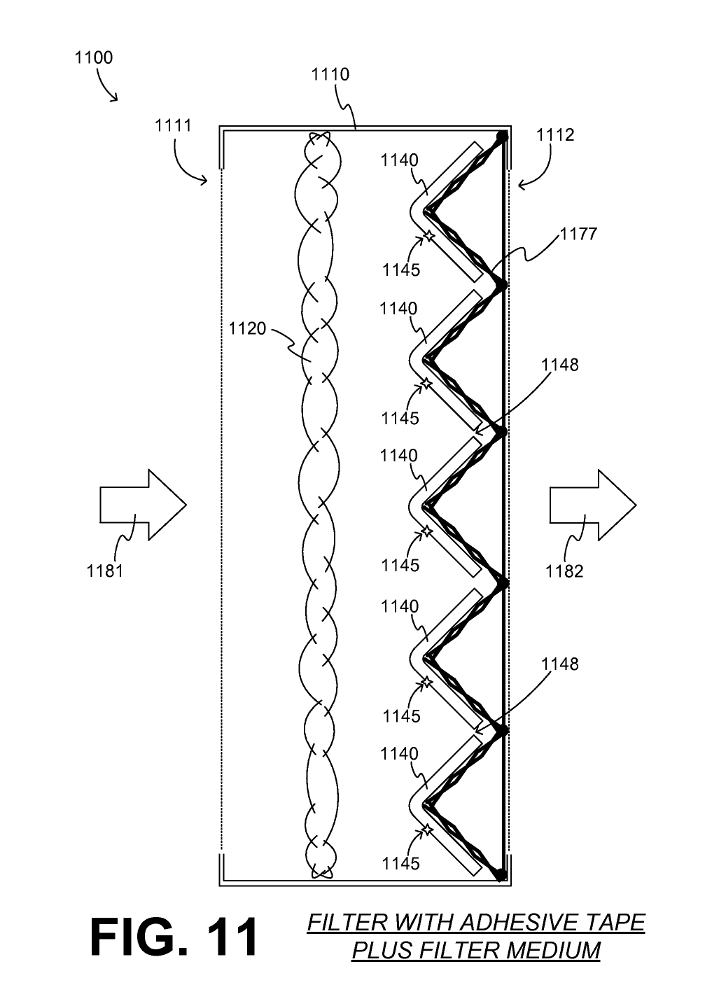

FIG. 11 is a diagram of a cross-section of a sample air filter 1100 made according to embodiments. As previously, filter 1100 includes a frame 1110. Frame 1110 includes a front opening 1111 and a back opening 1112. Filter 1100 is within an air flow 1181, 1182.

Filter 1100 also includes a tape support structure 1177, which can be as tape support structure 877. The individual components of tape support structure 1177, such as pleats, are not designated separately.

Filter 1100 also has tape segments 1140 arranged on the pleats of tape support structure 1177. Constrictions 1148 are formed, as discussed previously. Adhesive material 1145 has been deposited on tape segments 1140.

Filter 1100 additionally includes an air filter medium 1120 that can be as air filter medium 920. It will be appreciated that the shown portion of air filter medium 1120 is about in the middle of the distance between the edge of tape segments 1140 and front opening 1111. The reason can be that air filter medium 1120 can be folded in pleats, for example as shown in FIG. 10. In fact, FIG. 11 can be a cross-section along a line 1022 of FIG. 10.

In FIG. 11, it will be further appreciated that the tape direction, which is the direction parallel to the pleats of tape support structure 1177, is substantially perpendicular to the filter direction, which is the direction parallel to the pleats of air filter medium 1120. This arrangement may help package tape support structure 1177 and air filter medium 1120 more securely within frame 1110.

In order to make the composite embodiments of FIGS. 9-11 compatible with existing installations, the following may be considered. The frame may be the same size as in the existing installation, except that now it will have two components, not one. Each of the adhesive tape component and the conventional filter component will likely occupy the entire cross-section. For them to both fit in the z-direction, the pleats of the conventional filter (e.g. 1020) may be opened more widely.

In addition, it should be considered whether having both a conventional filter and an arrangement of tape segments according to embodiments will increase problematically the resistance faced by the fan or other air propulsion mechanism that establishes the air flow. It should be noted that the resistance contributed by the tape segments is likely less than the resistance already contributed by the air-permeable air filter medium 1120. Indeed, air must be driven through air-permeable air filter medium 1120, while it is driven only past tape segments 1140. This may become more of a problem if constrictions 1148 become too narrow.

It will be appreciated that above-mentioned adhesive tape is only one kind of many possible substrate types that can work in embodiments, so as to expose an adhesive ready to capture particulates from an air flow. Other substrate types are also possible.

In some embodiments, a sponge could be a substrate for such an adhesive, which can be made from sponge-like material. The air flow within the frame may be directed through the sponge. An adhesive material may have been deposited on the sponge, and capture particulates that flow through it.

Accordingly, an air filter configured to remove particulates from an air flow that is substantially contained within at least one duct portion may comprise: a frame distinct from the duct portion, the frame having a front opening and a back opening, the frame configured to be placed within the air flow such that the air flow enters the frame via the front opening and exits the frame via the back opening; and a sponge on which an adhesive material has been deposited.

In such an air filter, the adhesive material may have been deposited by soaking the sponge in a liquid solution that contains the adhesive material.

Or, in such an air filter, the adhesive material may have been deposited by spraying the sponge with a mist of a liquid solution that contains the adhesive material.

There are a number of ways of securing the sponge on the frame. In some embodiments, such an air filter could further comprise a sponge support structure configured to support the sponge on the frame. Such a sponge support structure could be made in different ways, such as described above, with a wire frame, etc.

In some embodiments, such an air filter could further comprise an air-permeable air filter medium distinct from the sponge. The air-permeable air filter medium can be supported on the frame and be configured to remove at least some of the particulates from the air flow. In some of these embodiments, the sponge is adhered to the air-permeable air filter medium, and thus uses it as its support structure.

In some embodiments, the above-mentioned air filter medium itself could have been prepared by depositing thereon an adhesive material. Particulates passing through such a filter may adhere to it better than they would adhere to a conventional air filter. Care should be taken that the solution used for the soaking or the spraying does not compromise the qualities of the air filter medium itself.

Accordingly, an air filter configured to remove particulates from an air flow that is substantially contained within at least one duct portion may comprise: a frame distinct from the duct portion, the frame having a front opening and a back opening, the frame configured to be placed within the air flow such that the air flow enters the frame via the front opening and exits the frame via the back opening; an air-permeable air filter medium supported on the frame and configured to remove at least some of the particulates from the air flow, the air-permeable air filter medium containing adhesive material that has been deposited thereon and is exposed to the air flow.

In such an air filter, the adhesive material may have been deposited by soaking the air filter medium in a liquid solution that contains the adhesive material.

Or, in such an air filter, the adhesive material may have been deposited by spraying the air filter medium with a mist of a liquid solution that contains the adhesive material.

In further embodiments, a filter arrangement may be made with a system that passes air through a liquid solution such as mentioned above. The air flow may be first converted to a stream of air bubbles, by using one or more nozzles. The air bubbles may rise through the liquid solution, and their particulates may adhere to the adhesive material, thus precipitating away. Effectiveness can be improved if the air bubbles are small in diameter, so as to increase the air flow's total surface area contacting the fluid solution.

A person skilled in the art will be able to practice the present invention in view of this description, which is to be taken as a whole. Details have been included to provide a thorough understanding. In other instances, well-known aspects have not been described, in order to not obscure unnecessarily the present invention. Plus, any reference to any prior art in this description is not, and should not be taken as, an acknowledgement or any form of suggestion that this prior art forms parts of the common general knowledge in any country.

This description includes one or more examples, but that inclusion does not limit how the invention may be practiced. Indeed, examples or embodiments of the invention may be practiced according to what is described, or yet differently, and also in conjunction with other present or future technologies. Other embodiments include combinations and sub-combinations of features described herein, including for example, embodiments that are equivalent to the following: providing or applying a feature in a different order than in a described embodiment; extracting an individual feature from one embodiment and inserting such feature into another embodiment; removing one or more features from an embodiment; or both removing a feature from an embodiment and adding a feature extracted from another embodiment, while providing the features incorporated in such combinations and sub-combinations.

In this document, the phrases “constructed to” and/or “configured to” denote one or more actual states of construction and/or configuration that is fundamentally tied to physical characteristics of the element or feature preceding these phrases and, as such, reach well beyond merely describing an intended use. Any such elements or features can be implemented in a number of ways, as will be apparent to a person skilled in the art after reviewing the present disclosure, beyond any examples shown in this document.

The following claims define certain combinations and subcombinations of elements, features and steps or operations, which are regarded as novel and non-obvious. Additional claims for other such combinations and subcombinations may be presented in this or a related document.

1. An air filter configured to remove particulates from an air flow that is substantially contained within at least one duct portion, the air filter comprising:
a frame distinct from the duct portion, the frame having a front opening and a back opening, the frame configured to be placed within the air flow such that the air flow enters the frame via the front opening and exits the frame via the back opening; and
a tape segment, the tape segment being a segment of a substantially air-impervious adhesive tape, the tape segment having a primary surface on which an adhesive material has been deposited, and a secondary surface opposite the primary surface, and
in which the tape segment is supported on the frame such that at least an exposed portion of the primary surface is exposed to the air flow so that at least some of the particulates in the air flow adhere to the exposed portion of the primary surface while the air flow substantially does not flow through the tape segment.

2. The air filter of claim 1, in which
the tape segment is a segment of a pressure-sensitive adhesive tape.

3. The air filter of claim 1, in which
the exposed portion of the primary surface has an area of at least 10 cm².

4. The air filter of claim 1, in which
at least a section of the tape segment has been electrostatically charged.

5. The air filter of claim 1, in which
the tape segment is supported on the frame due to adhesion of the adhesive material that has been deposited on the primary surface.

6. The air filter of claim 1, in which
the tape segment is supported between the front opening and the back opening.

7. The air filter of claim 1, in which
the frame includes tabs, and the tape segment is supported by the tabs.

8. The air filter of claim 7, in which
the tabs are between the front opening and the back opening.

9. The air filter of claim 7, in which
the tape segment is supported on the frame due to adhesion of the adhesive material that has been deposited on the primary surface.

10. The air filter of claim 1, in which
the air flow travels along a primary direction, and
at least a part of the exposed portion of the primary surface is disposed in a tape plane that is at an oblique angle with respect to the primary direction.

11. The air filter of claim 1, in which
the air flow is deflected by the tape segment.

12. The air filter of claim 1, in which
an adhesive material has been deposited also on the secondary surface, and
the tape segment is supported on the frame such that at least an exposed portion of the secondary surface is exposed to the air flow so that at least some of the particulates in the air flow adhere to the exposed portion of the secondary surface.

13. The air filter of claim 12, in which
the exposed portion of the secondary surface has an area of at least 10 cm².

14. The air filter of claim 1, further comprising:
a tape support structure configured to support the tape segment on the frame.

15. The air filter of claim 14, in which
the tape support structure includes a grid.

16. The air filter of claim 14, in which
the tape support structure is not attached to the frame.

17. The air filter of claim 14, in which
the tape segment is adhered to the tape support structure.

18. The air filter of claim 14, in which
an adhesive material has been deposited also on the secondary surface, and
the tape segment is adhered to the tape support structure due to adhesion of the adhesive material that has been deposited on the secondary surface.

19. The air filter of claim 1, further comprising:
an air-permeable air filter medium distinct from the tape segment, the air-permeable air filter medium supported on the frame and configured to remove at least some of the particulates from the air flow.

20-23. (canceled)

24. An air filter configured to remove particulates from an air flow that is substantially contained within at least one duct portion, the air filter comprising:
a frame distinct from the duct portion, the frame having a front opening and a back opening, the frame configured to be placed within the air flow such that the air flow enters the frame via the front opening and exits the frame via the back opening;
an air-permeable air filter medium supported on the frame and configured to remove at least some of the particulates from the air flow; and
a plurality of tape segments, the tape segments being segments of a substantially air-impervious adhesive tape, the tape segments distinct from the air-permeable air filter medium, the tape segments having respective primary surfaces on which an adhesive material has been deposited, and respective secondary surfaces opposite the respective primary surfaces, and
in which the tape segments are supported on the frame such that at least respective exposed portions of their respective primary surfaces are exposed to the air flow so that at least some of the particulates in the air flow adhere to the respective exposed portions while the air flow substantially does not flow through the tape segments.

25-35. (canceled)
